(19) United States
(12) Patent Application Publication
(10) Pub. No.: US 2026/0230624 A1
(43) Pub. Date: Aug. 6, 2026

(54) Optimizing Signalling For Preprocessing

(71) Applicant: Bytedance Inc., Los Angeles, CA (US)

(72) Inventors: Wei JIA, San Diego, CA (US); Yue LI, San Diego, CA (US); Ye-Kui WANG, San Diego, CA (US); Kai ZHANG, San Diego, CA (US); Li ZHANG, San Diego, CA (US)

(21) Appl. No.: 19/636,647

(22) Filed: Apr. 1, 2026

Related U.S. Application Data
(63) Continuation of application No. PCT/US2024/050036, filed on Oct. 4, 2024.
(60) Provisional application No. 63/588,225, filed on Oct. 5, 2023.

(51) Int. Cl. H04N 19/136; H04N 19/70

(52) U.S. Cl. CPC H04N 19/136; H04N 19/70

(57) ABSTRACT

A mechanism for processing video data is disclosed. The mechanism includes determining that preprocessing information including properties or parameters of optimizing filters is included in a bitstream. A conversion is performed between a visual media data and a bitstream based on the preprocessing information.

### CROSS-REFERENCE TO RELATED APPLICATIONS

This is a continuation of International Patent Application No. PCT/US2024/050036, filed on Oct. 4, 2024, which claims the priority to and benefits of U.S. Provisional Patent Application No. 63/588,225, filed on Oct. 5, 2023. All the aforementioned patent applications are hereby incorporated by reference in their entireties.

### TECHNICAL FIELD

The present disclosure relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing video data comprising: determining preprocessing information including properties or parameters of optimizing filters is included in a bitstream; and performing a conversion between a visual media data and a bitstream based on the preprocessing information.

A second aspect relates to an apparatus for processing video data comprising: a processor; and a non-transitory memory with instructions thereon, wherein the instructions upon execution by the processor, cause the processor to perform any of the preceding aspects.

A third aspect relates to non-transitory computer readable medium comprising a computer program product for use by a video coding device, the computer program product comprising computer executable instructions stored on the non-transitory computer readable medium such that when executed by a processor cause the video coding device to perform the method of any of the preceding aspects.

A fourth aspect relates to a non-transitory computer-readable recording medium storing a bitstream of a video which is generated by a method performed by a video processing apparatus, wherein the method comprises: determining preprocessing information including properties or parameters of optimizing filters is included in a bitstream; and generating a bitstream based on the determining.

A fifth aspect relates to a method for storing bitstream of a video comprising: determining preprocessing information including properties or parameters of optimizing filters is included in a bitstream; generating a bitstream based on the determining; and storing the bitstream in a non-transitory computer-readable recording medium.

A sixth aspect relates to a method, apparatus, or system described in the present disclosure.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram showing an example video processing system.

FIG. 2 is a block diagram of an example video processing apparatus.

FIG. 3 is a flowchart for an example method of video processing.

FIG. 4 is a block diagram that illustrates an example video coding system.

FIG. 5 is a block diagram that illustrates an example encoder.

FIG. 6 is a block diagram that illustrates an example decoder.

FIG. 7 is a schematic diagram of an example encoder.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and embodiments illustrated below, including the exemplary designs and implementations illustrated and described herein, but may be modified within the scope of the appended claims along with their full scope of equivalents.

Section headings are used in the present disclosure for ease of understanding and do not limit the applicability of techniques and embodiments disclosed in each section only to that section. Furthermore, H.266 terminology is used in some description only for ease of understanding and not for limiting scope of the disclosed embodiments. As such, the embodiments described herein are applicable to other video codec protocols and designs also. In the present disclosure, editing changes are shown to text by bold italics indicating cancelled text and bold indicating added text, with respect to the Versatile Video Coding (VVC) specification.

### 1. INITIAL DISCUSSION

This disclosure is related to image/video coding technologies. Specifically, this disclosure is related to the purpose and various constraints for neural-network post-processing filters (NNPF). The ideas may be applied individually or in various combinations, for video bitstreams coded by any codec, e.g., the versatile video coding (VVC) standard and/or the versatile supplemental enhancement information (SEI) messages for coded video bitstreams (VSEI) standard.

### 2. ABBREVIATIONS

The present disclosure includes the following abbreviations. Adaptation parameter set (APS), access unit (AU), coded layer video sequence (CLVS), coded layer video sequence start (CLVSS), cyclic redundancy check (CRC), coded video sequence (CVS), finite impulse response (FIR), intra random access point (IRAP), network abstraction layer (NAL), picture parameter set (PPS), prediction unit (PU), random access skipped leading (RASL) picture, supplemental enhancement information (SEI), step-wise temporal sublayer access (STSA), video coding layer (VCL), versatile supplemental enhancement information as described in Rec. ITU-T H.274|ISO/IEC 23002-7 (VSEI), video usability information (VUI), versatile video coding as described in Rec. ITU-T H.266|ISO/IEC 23090-3 (VVC)

### 3. FURTHER DISCUSSION

### 3.1 Video Coding Standards

Video coding standards have evolved primarily through the development of International Telecommunication Union (ITU) telecommunication standardization sector (ITU-T) and International Organization for Standardization (ISO)/International Electrotechnical Commission (IEC) standards. The ITU-T produced H.261 and H.263, ISO/IEC produced motion picture experts group (MPEG)-1 and MPEG-4 Visual, and the two organizations jointly produced the H.262/MPEG-2 Video and H.264/MPEG-4 Advanced Video Coding (AVC) and H.265/high efficiency video coding (HEVC) [1] standards. Since H.262, the video coding standards are based on the hybrid video coding structure wherein temporal prediction plus transform coding are utilized. To explore video coding technologies beyond high efficiency video coding (HEVC), the Joint Video Exploration Team (JVET) was founded by video coding experts group (VCEG) and motion picture experts group (MPEG). Further, methods have been adopted by JVET and put into the reference software named Joint Exploration Model (JEM) [2]. The JVET was later renamed to be the Joint Video Experts Team (JVET) when the Versatile Video Coding (VVC) project officially started. VVC [3] is a coding standard targeting a 50% bitrate reduction as compared to HEVC.

The Versatile Video Coding (VVC) standard (ITU-T H.266|ISO/IEC 23090-3) [3] and the associated Versatile Supplemental Enhancement Information for coded video bitstreams (VSEI) standard (ITU-T H.274|ISO/IEC 23002-7) [4] are designed for use in a maximally broad range of applications, including both the simple uses such as television broadcast, video conferencing, or playback from storage media, and also more advanced use cases such as adaptive bit rate streaming, video region extraction, composition and merging of content from multiple coded video bitstreams, multiview video, scalable layered coding, and viewport-adaptive 360° immersive media.

The Essential Video Coding (EVC) standard (ISO/IEC 23094-1) is another video coding standard under development by MPEG.

### 3.2 SEI Messages in General and in VVC and VSEI

SEI messages assist in processes related to decoding, display or other purposes. However, SEI messages are not required for constructing the luma or chroma samples by the decoding process. Conforming decoders are not required to process this information for output order conformance. Some SEI messages are required for checking bitstream conformance and for output timing decoder conformance. Other SEI messages are not required for check bitstream conformance.

Annex D of VVC specifies syntax and semantics for SEI message payloads for some SEI messages, and specifies the use of the SEI messages and VUI parameters for which the syntax and semantics are specified in ITU-T H.274|ISO/IEC 23002-7.

### 3.3 Technologies Under Consideration for Signalling of Neural-Network Post-Filters

JVET-AE2032 [5] contains draft text to modify the neural-network post-filter SEI messages and draft text to specify the encoder optimization SEI message, source picture timing SEI message, object mask information SEI message, and neural-network post-filter group SEI message. The partial specification of NNPFC and NNPFA SEI message changes in JVET-AE2032 are as follows.

Renumber the current subclause 8.30 as 8.33 and add subclauses 8.30 to 8.32 as follows:
8.30 Encoder optimization information SEI message
8.30.1 Encoder optimization information SEI message syntax

| | Descriptor |
|---|---|
| encoder_optimization_info(payloadSize ) { | |
| optimization_cancel_flag | u(1) |
| if( !optimization_cancel_flag ){ | |
| optimization_persistence_flag | u(1) |
| optimization_for_human_viewing_flag | u(1) |
| optimization_for_machine_analysis_flag | u(1) |
| optimization_type | u(16) |
| } | |
| } | |

8.30.2 Encoder optimization information SEI message semantics

optimization_cancel_flag equal to 1 specifies that the persistence of the previous applied optimization is cancelled. optimization_cancel_flag equal to 0 indicates that optimization_persistence_flag and optimization_method follow.

optimization_persistence_flag specifies the persistence of the optimization the current layer. optimization_persistence_flag equal to 0 specifies that the optimization applies for the current picture only. optimization_persistence_flag equal to 1 specifies that the optimization applies for the current picture and all subsequent pictures of the current layer in output order until one or more of the following conditions are true:
A new CLVS of the current layer begins.
The bitstream ends.
A picture in the current layer associated with an encoder_optimization_info SEI message is output that follows the current picture in output order.

optimization_for_human_viewing_flag equal to 1 specifies that purposes for the applied optimization include human viewing. optimization_for_human_viewing_flag equal to 0 specifies that purposes for the applied optimization may or may not include human viewing.

optimization_for_machine_analysis_flag equal to 1 specifies that purposes for the applied optimization include machine analysis. optimization_for_machine_analysis_flag equal to 0 specifies that purposes for the applied optimization may or may not include machine analysis.

optimization_type indicates the types of optimization method as specified in Table 2.

TABLE 2
Definition of optimization_type

| Value | Interpretation |
|---|---|
| optimization_type == 0 | May be used as determined by the application |
| optimization_type > 0 && | No object-based optimization |
| ( optimization_type & | |
| 0x01 ) == 0 | |
| ( optimization_type & | With object-based optimization; the pictures for which this SEI message persists |
| 0x01 ) != 0 | have been pre-processed or encoded so that detected objects in the pictures are |
| | optimized with respect to other parts of the pictures for the indicated |
| | optimization purposes |
| optimization_type > 0 && | No temporal subsampling optimization |
| ( optimization_type & | |
| 0x02 ) == 0 | |
| ( optimization_type & | With temporal subsampling optimization |
| 0x02 ) != 0 | |
| optimization_type > 0 && | No spatial subsampling optimization |
| ( optimization_type & | |
| 0x04 ) == 0 | |
| ( optimization_type & | With spatial subsampling optimization |
| 0x04 ) != 0 | |
| optimization_type > 0 && | No temporal quality optimization |
| ( optimization_type & | |
| 0x08 ) == 0 | |
| ( optimization_type & | With temporal quality optimization |
| 0x08 ) != 0 | |
| optimization_type > 0 && | No spatial quality optimization |
| ( optimization_type & | |
| 0x10 ) == 0 | |
| ( optimization_type & | With spatial quality optimization; the pictures for which this SEI message |
| 0x10 ) != 0 | persists have been pre-processed or encoded to reduce unnecessary information |
| | or improve the quality of necessary information. (e.g., to reduce the amount of |
| | noise and remove speckles at the picture-level) |

### 4. TECHNICAL PROBLEMS SOLVED BY DISCLOSED EMBODIMENTS

An example design for signalling encoder preprocessing and human/machine viewing indications has the following problems:

The following semantics are specified on optimization_type. optimization_type indicates the types of optimization method as specified in Table 2 as described above. Table 2 is reproduced below for convenience.

TABLE 2
Definition of optimization_type

| Value | Interpretation |
|---|---|
| optimization_type == 0 | May be used as determined by the application |
| optimization_type > 0 && | No object-based optimization |
| ( optimization_type & | |
| 0x01 ) == 0 | |
| ( optimization_type & | With object-based optimization; the pictures for which this SEI message persists |
| 0x01 ) != 0 | have been pre-processed or encoded so that detected objects in the pictures are |
| | optimized with respect to other parts of the pictures for the indicated |
| | optimization purposes |
| optimization_type > 0 && | No temporal subsampling optimization |
| ( optimization_type & | |
| 0x02 ) == 0 | |
| ( optimization_type & | With temporal subsampling optimization |
| 0x02 ) != 0 | |
| optimization_type > 0 && | No spatial subsampling optimization |
| ( optimization_type & | |
| 0x04 ) == 0 | |
| ( optimization_type & | With spatial subsampling optimization |
| 0x04 ) != 0 | |
| optimization_type > 0 && | No temporal quality optimization |
| ( optimization_type & | |
| 0x08 ) == 0 | |
| ( optimization_type & | With temporal quality optimization |
| 0x08 ) != 0 | |
| optimization_type > 0 && | No spatial quality optimization |
| ( optimization_type & | |
| 0x10 ) == 0 | |
| ( optimization_type & | With spatial quality optimization; the pictures for which this SEI message |
| 0x10 ) != 0 | persists have been pre-processed or encoded to reduce unnecessary information |
| | or improve the quality of necessary information. (e.g., to reduce the amount of |
| | noise and remove speckles at the picture-level) |

However, the optimizing filters employed in the encoder preprocessing are not signalled to the decoder. As a result, the decoder cannot use the information to optimize postprocessing designs. Hence, embodiments of this disclosure may include an encoder that signals the information of optimizing filters to the decoder to help the decoder to reconstruct for a higher quality.

### 5. A LISTING OF SOLUTIONS AND EMBODIMENTS

To solve the above-described problems, methods as summarized below are disclosed. The aspects should be considered as examples to explain the general concepts and should not be interpreted in a narrow way. Furthermore, these examples can be applied individually or combined in any manner.
1) It is proposed that the encoder may signal information used in preprocessing, such as properties and/or parameters of optimizing filters in the preprocessing.
   a. In one example, the encoder may signal the filter type when the optimization type indicates the spatial subsampling.
      i. In one example, the encoder may signal the filter type as nearest neighbor interpolation used in the encoder preprocessing optimization.
      ii. In one example, the encoder may signal the filter type as bilinear interpolation used in the encoder preprocessing optimization.
      iii. In one example, the encoder may signal the filter type as bicubic interpolation used in the encoder preprocessing optimization.
      iv. In one example, the encoder may signal the filter type as Lanczos interpolation used in the encoder preprocessing optimization.
      v. In one example, the encoder may signal the filter type as bit exact bilinear interpolation used in the encoder preprocessing optimization.
      vi. In one example, the encoder may signal the filter type as bit exact nearest neighbor interpolation used in the encoder preprocessing optimization.
      vii. In one example, the encoder may signal the filter type as mask for interpolation codes used in the encoder preprocessing optimization.
      viii. In one example, the encoder may signal the filter type as neural network filter in the format of an ISO/IEC 15938-17 bitstream used in the encoder preprocessing optimization.
      ix. In one example, the encoder may signal the filter type as neural network filter in the format of uniform resource identifier (URI used in the encoder preprocessing optimization.
   b. In one example, the encoder may signal the filter type when the optimization type indicates the temporal subsampling.
      i. In one example, the encoder may signal the original and subsampled frame rates used in the encoder preprocessing optimization.
      ii. In one example, the encoder may signal the original frame rate and the subsampling scale coefficient used in the encoder preprocessing optimization.
      iii. In one example, the encoder may signal the subsampled frame rate and the subsampling scale coefficient used in the encoder preprocessing optimization.
   c. In one example, the encoder may signal the filter type when the optimization type indicates the object-based optimization.
      i. In one example, the encoder may signal the filter type as neural network filter with you only look once (YOLO) used in the encoder preprocessing optimization.
      ii. In one example, the encoder may signal the filter type as neural network filter with Faster region-based convolutional neural network (R-CNN) used in the encoder preprocessing optimization.
      iii. In one example, the encoder may signal the filter type as neural network filter in the format of an ISO/IEC 15938-17 bitstream used in the encoder preprocessing optimization.
      iv. In one example, the encoder may signal the filter type as neural network filter in the format of URI used in the encoder preprocessing optimization.
   d. In one example, the encoder may signal the filter type when the optimization type indicates the temporal quality.
      i. In one example, the encoder may signal the filter type as neural network filter in the format of an ISO/IEC 15938-17 bitstream used in the encoder preprocessing optimization.
      ii. In one example, the encoder may signal the filter type as neural network filter in the format of URI used in the encoder preprocessing optimization.
   e. In one example, the encoder may signal the filter type when the optimization type indicates spatial quality.
      i. In one example, the encoder may signal the filter type as neural network filter in the format of an ISO/IEC 15938-17 bitstream used in the encoder preprocessing optimization.
      ii. In one example, the encoder may signal the filter type as neural network filter in the format of URI used in the encoder preprocessing optimization.
2) It is proposed that the encoder may signal the amount information of optimizing filters in the preprocessing.
   a. In one example, the encoder may signal the specific number per an applied optimization type.
      i. In one example, the encoder may signal the number of filters applied with the optimization type indicating the object-based optimization.
      ii. In one example, the encoder may signal the number of filters applied with the optimization type indicating the temporal subsampling optimization.
      iii. In one example, the encoder may signal the number of filters applied with the optimization type indicating the spatial subsampling optimization.
      iv. In one example, the encoder may signal the number of filters applied with the optimization type indicating the temporal quality optimization.
      v. In one example, the encoder may signal the number of filters applied with the optimization type indicating the spatial quality optimization.
3) The information disclosed may be signaled as at least one syntax element (SE).
   a. The SE may be binarized as a flag, a fixed length code, an EG(x) code, a unary code, a truncated unary code, a truncated binary code, etc. It can be signed or unsigned.
   b. The SE may be coded with at least one context model. Or it may be bypass coded.
   c. The SE may be signaled in a conditional way.
      i. The SE is signaled only if the corresponding function is applicable.
      ii. The SE is signaled only if the dimensions (width and/or height) of the block satisfy a condition.
   d. The SE may be signaled at block level/sequence level/group of pictures level/picture level/slice level/tile group level, such as in coding structures of coding tree unit (CTU)/coding unit (CU)/transform unit (TU)/prediction unit (PU)/coding tree block (CTB)/coding block (CB)/transform block (TB)/prediction block (PB), or sequence header/picture header/sequence parameter set (SPS)/video parameter set (VPS)/dependency parameter set (DPS)/decoding capability information (DCI)/picture parameter set (PPS)/adaptation parameter set (APS)/slice header/tile group header.
   e. The SE may be signaled in supplemental enhancement information (SEI).

Whether to and/or how to apply the disclosed methods above may be signalled at block level/sequence level/group of pictures level/picture level/slice level/tile group level, such as in coding structures of CTU/CU/TU/PU/CTB/CB/TB/PB, or sequence header/picture header/SPS/VPS/DPS/DCI/PPS/APS/slice header/tile group header.

### 6. EMBODIMENTS

Below are some example embodiments for the aspects summarized above in Section 5.

Most relevant parts that have been added or modified are in “{{ }}”, and some of the deleted parts are in “/**\”. There may be some other changes that are editorial in nature and thus not indicated.

### 6.1 Embodiment 1

This embodiment is for item 1 and all their subitems as summarized above in Section 5.
8.30.1 Encoder optimization information SEI message syntax

| | Descriptor |
|---|---|
| encoder_optimization_info(payloadSize ) { | |
| optimization_cancel_flag | u(1) |
| if( !optimization_cancel_flag ){ | |
| optimization_persistence_flag | u(1) |
| optimization_for_human_viewing_flag | u(1) |
| optimization_for_machine_analysis_flag | u(1) |
| optimization_type | u(16) |
| {{ if ( optimization_type & 0x04 ) != 0 ) { | |
| optimization_spatial_subsampling_filter_type | u(7) |
| } }} | |
| } | |
| } | |

8.30.2 Encoder optimization information SEI message semantics
. . .

optimization_type indicates the types of optimization method as specified in Table 2.

TABLE 2
Definition of optimization_type

| Value | Interpretation |
|---|---|
| optimization_type == 0 | May be used as determined by the application |
| optimization_type > 0 && | No object-based optimization |
| ( optimization_type & | |
| 0x01 ) == 0 | |
| ( optimization_type & | With object-based optimization; the pictures for which this SEI message persists |
| 0x01 ) != 0 | have been pre-processed or encoded so that detected objects in the pictures are |
| | optimized with respect to other parts of the pictures for the indicated |
| | optimization purposes |
| optimization_type > 0 && | No temporal subsampling optimization |
| ( optimization_type & | |
| 0x02 ) == 0 | |
| ( optimization_type & | With temporal subsampling optimization |
| 0x02 ) != 0 | |
| optimization_type > 0 && | No spatial subsampling optimization |
| ( optimization_type & | |
| 0x04 ) == 0 | |
| ( optimization_type & | With spatial subsampling optimization |
| 0x04 ) != 0 | |
| optimization_type > 0 && | No temporal quality optimization |
| ( optimization_type & | |
| 0x08 ) == 0 | |
| ( optimization_type & | With temporal quality optimization |
| 0x08 ) != 0 | |
| optimization_type > 0 && | No spatial quality optimization |
| ( optimization_type & | |
| 0x10 ) == 0 | |
| ( optimization_type & | With spatial quality optimization; the pictures for which this SEI message |
| 0x10 ) != 0 | persists have been pre-processed or encoded to reduce unnecessary information |
| | or improve the quality of necessary information. (e.g., to reduce the amount of |
| | noise and remove speckles at the picture-level) |

{{optimization_spatial_subsampling_filter_type indicates the types of spatial subsampling filters as specified in Table 25.

The value of optimization_spatial_subsampling_filter_type shall be in the range of 0 to 7, inclusive, in bitstreams conforming to this edition of this document. Values of 8 to 127, inclusive, for optimization_spatial_subsampling_filter_type are reserved for future use by ITU-T| ISO/IEC and shall not be present in bitstreams conforming to this edition of this document. Decoders conforming to this edition of this document shall ignore optimization_spatial_subsampling_filter_type in the range of 8 to 127, inclusive.

TABLE 25
Definition of optimization_spatial_subsampling_filter_type

| Value | Interpretation |
|---|---|
| 0 | May be used as determined by the application |
| 1 | bilinear interpolation |
| 2 | bicubic interpolation |
| 3 | nearest neighbor interpolation |
| 4 | Lanczos interpolation |
| 5 | bit exact bilinear interpolation |
| 6 | bit exact nearest neighbor interpolation |
| 7 | mask for interpolation codes |

}}

### 7. REFERENCES

[1] ITU-T and ISO/IEC, “High efficiency video coding”, Rec. ITU-T H.265|ISO/IEC 23008-2 (in force edition).
[2] J. Chen, E. Alshina, G. J. Sullivan, J.-R. Ohm, J. Boyce, “Algorithm description of Joint Exploration Test Model 7 (JEM7),” JVET-G1001, August 2017.
[3] Rec. ITU-T H.266|ISO/IEC 23090-3, “Versatile Video Coding”, 2022.
[4] Rec. ITU-T Rec. H.274|ISO/IEC 23002-7, “Versatile Supplemental Enhancement Information Messages for Coded Video Bitstreams”, 2022.
[5] M. M. Hannuksela, J. Chen, S. Deshpande, S. McCarthy, “Technologies under consideration for future extensions of VSEI (draft 1)”, JVET output document JVET-AE2032, publicly available online herein: https://jvet-experts.org/doc_end_user/current_document.php?id=13282.

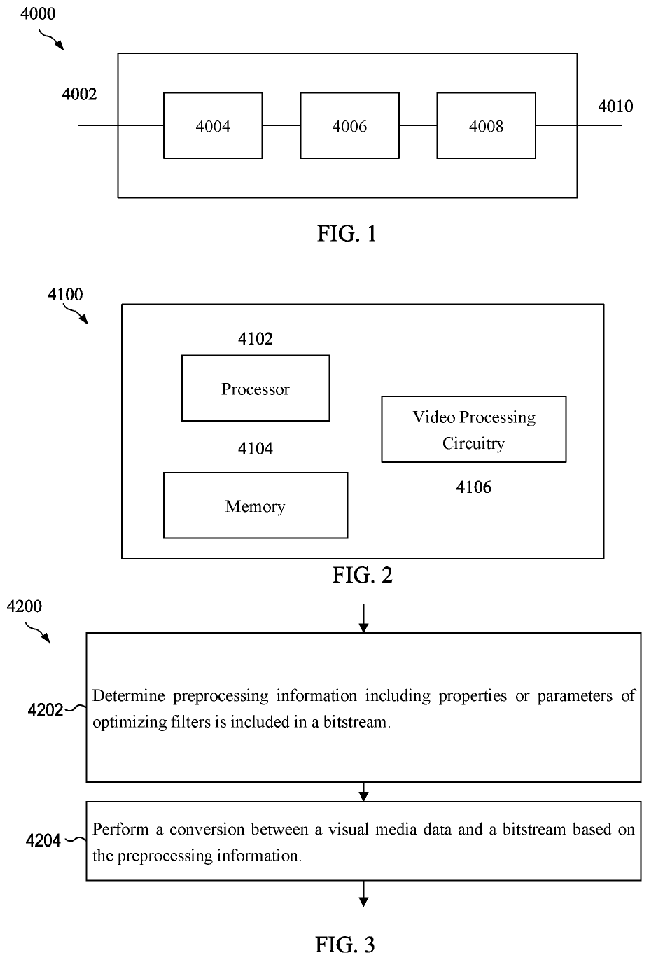

FIG. 1 is a block diagram showing an example video processing system 4000 in which various embodiments disclosed herein may be implemented. Various implementations may include some or all of the components of the system 4000. The system 4000 may include input 4002 for receiving video content. The video content may be received in a raw or uncompressed format, e.g., 8- or 10-bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as Wi-Fi or cellular interfaces.

The system 4000 may include a coding component 4004 that may implement the various coding or encoding methods described in the present disclosure. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or DisplayPort, and so on. Examples of storage interfaces include serial advanced technology attachment (SATA), peripheral component interconnect (PCI), integrated drive electronics (IDE) interface, and the like. The embodiments described in the present disclosure may be embodied in various electronic devices such as mobile phones, laptops, smartphones or other devices that are capable of performing digital data processing and/or video display.

FIG. 2 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present disclosure. The memory (memories) 4104 may be used for storing data and code used for implementing the methods and embodiments described herein. The video processing circuitry 4106 may be used to implement, in hardware circuitry, some embodiments described in the present disclosure. In some embodiments, the video processing circuitry 4106 may be at least partly included in the processor 4102, e.g., a graphics co-processor.

FIG. 3 is a flowchart for an example method 4200 of video processing. The method 4200 determines preprocessing information including properties or parameters of optimizing filters is included in a bitstream at step 4202. A conversion between a visual media data and a bitstream is performed based on the preprocessing information at step 4204. The conversion may include encoding at an encoder, decoding at a decoder, or combinations thereof.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

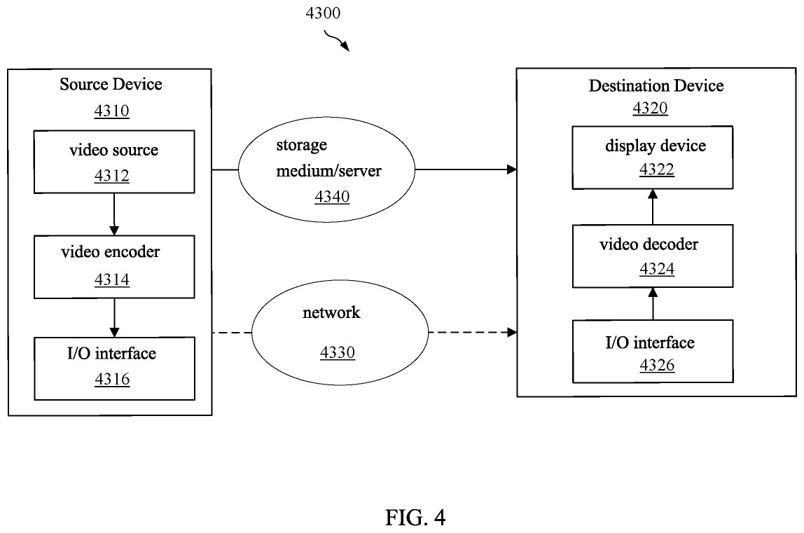

FIG. 4 is a block diagram that illustrates an example video coding system 4300 that may utilize the embodiments of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVC) standard and other current and/or further standards.

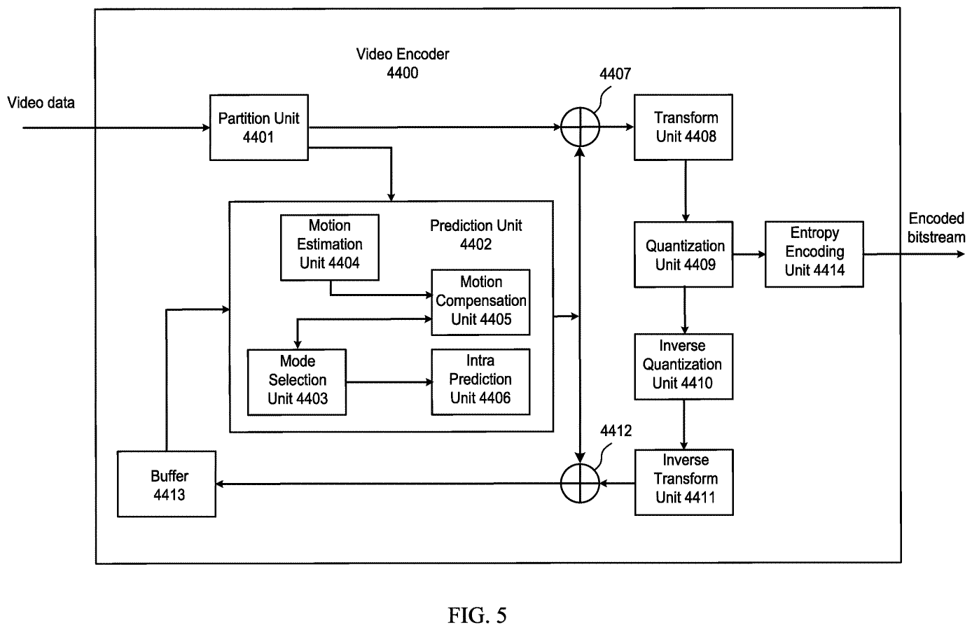

FIG. 5 is a block diagram illustrating an example of video encoder 4400, which may be video encoder 4314 in the system 4300 illustrated in FIG. 4. Video encoder 4400 may be configured to perform any or all of the embodiments of this disclosure. The video encoder 4400 includes a plurality of functional components. The embodiments described in this disclosure may be shared among the various components of video encoder 4400. In some examples, a processor may be configured to perform any or all of the embodiments described in this disclosure.

The functional components of video encoder 4400 may include a partition unit 4401; a prediction unit 4402, which may include a mode select unit 4403, a motion estimation unit 4404, a motion compensation unit 4405, and an intra prediction unit 4406; a residual generation unit 4407; a transform processing unit 4408; a quantization unit 4409; an inverse quantization unit 4410; an inverse transform unit 4411; a reconstruction unit 4412; a buffer 4413; and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

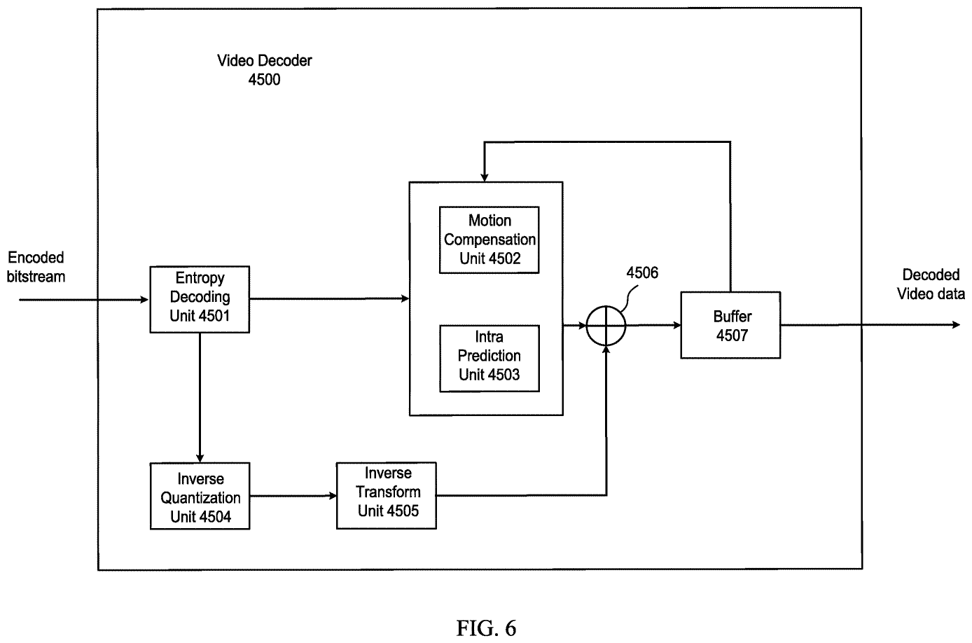

FIG. 6 is a block diagram illustrating an example of video decoder 4500 which may be video decoder 4324 in the system 4300 illustrated in FIG. 4. The video decoder 4500 may be configured to perform any or all of the embodiments of this disclosure. In the example shown, the video decoder 4500 includes a plurality of functional components. The embodiments described in this disclosure may be shared among the various components of the video decoder 4500. In some examples, a processor may be configured to perform any or all of the embodiments described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

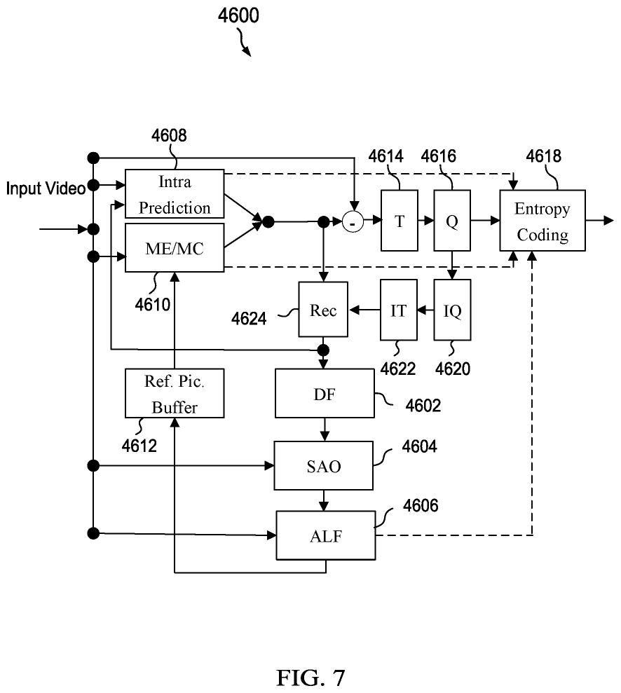

FIG. 7 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) component 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

A listing of solutions preferred by some examples is provided next.

The following solutions show examples of embodiments discussed herein.

1. A method for processing media data comprising: determining preprocessing information including properties or parameters of optimizing filters is included in a bitstream; and performing a conversion between a visual media data and a bitstream based on the preprocessing information.

2. The method of solution 1, wherein a filter type is signalled when an optimization type indicates spatial subsampling.

3. The method of any of solutions 1-2, wherein the bitstream contains an indication that one or more of the following are used in preprocessing optimization: nearest neighbor interpolation type, bilinear interpolation type, bicubic interpolation type, Lanczos interpolation type, bit exact bilinear interpolation type, bit exact nearest neighbor interpolation type, mask for interpolation codes type, neural network filter in ISO/IEC 15938-17 format type, and neural network filter in URI type.

4. The method of any of solutions 1-3, wherein a filter type is signalled when an optimization type indicates temporal subsampling.

5. The method of any of solutions 1-4, wherein the bitstream contains an indication of one or more of the following as used in preprocessing optimization: original and subsampled frame rates, original frame rate and the subsampling scale coefficient, and subsampled frame rate and the subsampling scale coefficient.

6. The method of any of solutions 1-5, wherein a filter type is signalled when an optimization type indicates object-based optimization.

7. The method of any of solutions 1-6, wherein the bitstream contains an indication that one or more of the following are used in preprocessing optimization: neural network filter with YOLO type, neural network filter with Faster R-CNN type, neural network filter in ISO/IEC 15938-17 format type, and neural network filter in URI type.

8. The method of any of solutions 1-7, wherein a filter type is signalled when an optimization type indicates temporal quality or spatial quality.

9. The method of any of solutions 1-8, wherein the bitstream contains an indication that one or more of the following are used in preprocessing optimization: neural network filter in ISO/IEC 15938-17 format type, and neural network filter in URI type.

10. The method of any of solutions 1-9, wherein the bitstream contains an indication of an amount information used by optimizing filters in preprocessing optimization.

11. The method of any of solutions 1-10, wherein the bitstream contains an indication of a specific number of filters per an applied optimization type.

12. The method of any of solutions 1-11, wherein the bitstream contains an indication of a number of filters applied with an optimization type, and wherein the optimization type is indicated as object-based optimization, temporal subsampling optimization, spatial subsampling optimization, temporal quality optimization, spatial quality optimization, or combinations thereof.

13. The method of any of solutions 1-12, wherein the preprocessing information is included in a syntax element coded according to a binarized as a flag, a fixed length code, an EG(x) code, a unary code, a truncated unary code, a truncated binary code, a signed element, an unsigned element, a context model, bypass coding, conditional coding, or combinations thereof.

14. The method of any of solutions 1-13, wherein the preprocessing information is signaled only when a corresponding function is applicable or only when width and/or height of a block satisfy a condition.

15. The method of any of solutions 1-14, wherein the preprocessing information is signaled at a block level, a sequence level, a group of pictures level, a picture level, a slice level, or a tile group level, or wherein the preprocessing information is signaled in a coding tree unit (CTU), coding unit (CU), transform unit (TU), prediction unit (PU), coding tree block (CTB), coding block (CB), transform block (TB), prediction block (PB), sequence header, picture header, sequence parameter set (SPS), video parameter se (VPS), dependency parameter set (DPS), Decoding Capability Information (DCI), picture parameter set (PPS), adaptation parameter set (APS), slice header, tile group header, or a supplemental enhancement information (SEI) message.

16. An apparatus for processing video data comprising: a processor; and a non-transitory memory with instructions thereon, wherein the instructions upon execution by the processor, cause the processor to perform the method of any of solutions 1-15.

17. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-15.

18. A non-transitory computer-readable recording medium storing a bitstream of a video which is generated by a method performed by a video processing apparatus, wherein the method comprises: determining preprocessing information including properties or parameters of optimizing filters is included in a bitstream; and generating a bitstream based on the determining.

19. A method for storing bitstream of a video comprising: determining preprocessing information including properties or parameters of optimizing filters is included in a bitstream; generating a bitstream based on the determining; and storing the bitstream in a non-transitory computer-readable recording medium.

20. A method, apparatus, or system described in the present disclosure.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present disclosure, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this disclosure can be implemented in digital electronic circuitry, or in computer software, firmware, or hardware, including the structures disclosed in this disclosure and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., a field-programmable gate array (FPGA) or an application-specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While the present disclosure contains many specifics, these should not be construed as limitations on the scope of any subject matter or of what may be claimed, but rather as descriptions of features that may be specific to particular embodiments of the present disclosure. Certain features that are described in the present disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

Only a few implementations and examples are described and other implementations, enhancements and variations can be made based on what is described and illustrated in the present disclosure.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, embodiments, systems, subsystems, and methods described and illustrated in the various embodiments as discrete or separate may be combined or integrated with other systems, modules, embodiments, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

1. A method for processing media data, comprising:
determining that preprocessing information including properties or parameters of optimizing filters is included in a bitstream; and
performing a conversion between visual media data and the bitstream based on the preprocessing information.

2. The method of claim 1, wherein a filter type is included in the bitstream when an optimization type indicates spatial subsampling.

3. The method of claim 1, wherein the bitstream contains an indication that indicates that one or more of the following filter types are used in preprocessing optimization: nearest neighbor interpolation type, bilinear interpolation type, bicubic interpolation type, Lanczos interpolation type, bit exact bilinear interpolation type, bit exact nearest neighbor interpolation type, mask for interpolation codes type, an ISO/IEC 15938-17 format type neural network filter, or a uniform resource identifier (URI) type neural network filter.

4. The method of claim 1, wherein a filter type is included in the bitstream when an optimization type indicates temporal subsampling.

5. The method of claim 1, wherein the bitstream contains an indication that indicates that one or more of the following are used in preprocessing optimization: an original frame rate and a subsampled frame rate, the original frame rate and a subsampling scale coefficient, or the subsampled frame rate and the subsampling scale coefficient.

6. The method of claim 1, wherein a filter type is included in the bitstream when an optimization type indicates object-based optimization.

7. The method of claim 1, wherein the bitstream contains an indication that indicates that one or more of following filter types are used in preprocessing optimization: a you only look once (YOLO) type neural network filter, a Faster region-based convolutional neural network (R-CNN) type neural network filter, an ISO/IEC 15938-17 format type neural network filter, or a uniform resource identifier (URI) type neural network filter.

8. The method of claim 1, wherein a filter type is included in the bitstream when an optimization type indicates temporal quality or spatial quality.

9. The method of claim 1, wherein the bitstream contains an indication that indicates that one or more of the following filter types are used in preprocessing optimization: neural network filter in ISO/IEC 15938-17 format type, or neural network filter in uniform resource identifier (URI) type.

10. The method of claim 1, wherein the bitstream contains an indication that indicates amount information of optimizing filters in preprocessing optimization.

11. The method of claim 1, wherein the bitstream contains an indication that indicates a specific number of filters per an applied optimization type.

12. The method of claim 1, wherein the bitstream contains an indication that indicates a number of filters applied with an optimization type, and wherein the optimization type indicates object-based optimization, temporal subsampling optimization, spatial subsampling optimization, temporal quality optimization, spatial quality optimization, or a combination thereof.

13. The method of claim 1, wherein the preprocessing information is represented by at least one syntax element that is binarized as a flag, a fixed length code, an EG(x) code, a unary code, a truncated unary code, a truncated binary code, a signed element, or an unsigned element.

14. The method of claim 13, wherein the at least one syntax element is coded with at least one context model, or the at least one syntax element is bypass coded, or the at least one syntax element is included in the bitstream in a conditional way.

15. The method of claim 13, wherein the at least one syntax element is included in the bitstream only when a corresponding function is applicable or only when a width and/or a height of a block satisfy a condition.

16. The method of claim 13, wherein the at least one syntax element is presented at a block level, a sequence level, a group of pictures level, a picture level, a slice level, or a tile group level, or wherein the at least one syntax element is presented in a coding tree unit (CTU), a coding unit (CU), a transform unit (TU), a prediction unit (PU), a coding tree block (CTB), a coding block (CB), a transform block (TB), a prediction block (PB), a sequence header, a picture header, a sequence parameter set (SPS), a video parameter set (VPS), a dependency parameter set (DPS), decoding capability information (DCI), a picture parameter set (PPS), an adaptation parameter set (APS), a slice header, a tile group header, or a supplemental enhancement information (SEI) message.

17. The method of claim 1, wherein the conversion includes encoding the visual media data into the bitstream.

18. The method of claim 1, wherein the conversion includes decoding the visual media data from the bitstream.

19. An apparatus for processing video data comprising a processor and a non-transitory memory with instructions thereon, wherein the instructions upon execution by the processor, cause the processor to:
determine that preprocessing information including properties or parameters of optimizing filters is included in a bitstream; and
perform a conversion between visual media data and the bitstream based on the preprocessing information.

20. A non-transitory computer-readable recording medium storing a bitstream of a video that is generated by a method performed by a video processing apparatus, wherein the method comprises:
determining that preprocessing information including properties or parameters of optimizing filters is included in the bitstream; and
generating the bitstream based on the preprocessing information.
